(19) United States
(12) Patent Application Publication
(10) Pub. No.: US 2009/0235532 A1
(43) Pub. Date: Sep. 24, 2009

(54) Pipe Cutting And Bevelling Tool

(76) Inventor: Robert M Stratford-Smith, Strathpine (AU)

Correspondence Address: HUDAK, SHUNK & FARINE, CO., L.P.A., 2020 FRONT STREET, SUITE 307, CUYAHOGA FALLS, OH, 44221, US

(21) Appl. No.: 12/225,053

(22) PCT Filed: Mar. 14, 2007
(86) PCT No.: PCT/AU2007/000318

§ 371 Date: Jan. 21, 2009

(30) Foreign Application Priority Data
Mar. 14, 2006 (AU) 2006201052

(51) Int. Cl. B23D 21/00; F16L 9/00; B26D 3/16

(52) U.S. Cl. 30/102; 138/178; 29/33 T; 30/388

(57) ABSTRACT

A pipe cutting and bevelling tool has a saw blade or abrasive disc and bevelling cutters or abrasive-coated drums extending through a slot in a first guide plate, the saw blade or abrasive disc and bevelling cutters, or abrasive-coated drums being driven by a suitable engine or motor. By selective angular adjustment of a second guide plate relative to the first guide plate the tool can cut and bevel pipes of a range of diameters, or cut different bevel depths in pipes of a given diameter.

### BACKGROUND OF THE INVENTION

1. Field of the Invention

THIS INVENTION relates to a pipe cutting and bevelling tool.

The invention is particularly suitable for, but not limited to, a cutting and bevelling tool for pipes used in civil construction and other infrastructure areas, including mechanical, and electrical and gas installations/pipes.

Throughout the specification, the term “pipe” shall include pipes, conduits and other tubular bodies.

2. Prior Art

The ends of pipes typically have to be bevelled so as to pass the rubber seals used in joints or fittings used to connect adjacent sections of pipe together.

Current practice, although officially not approved, is to cut the pipes with a cut-off saw and then bevel the ends of the pipes by using the side of the cut-off saw blade.

The cut-off saw is responsible for many incidents and injuries; and the disc/blade which has been weakened by using the side, instead of the cutting edge, which can be damaged by impact in handling or transport, and when shattered can be lethal. Furthermore, this process produces fine dust and smoke which may be inhaled; and it also produces heat which can damage the plastics or metal at the circumferential zone at the pipe ends being bevelled.

It is important that the depth of bevelling is adjustable (and can be accurately controlled) to accommodate different wall thicknesses. Good pipe laying practice requires there be a “landing” face on the ends of the pipes, and not a feather edge (which can damage the rubber seals).

The landing faces must be square to the longitudinal axes of their-pipes to minimize damage to the rubber seals.

While the bevelling can be produced by hand tools, this is slow and requires the use of an accurate cut-off tool to cut the pipes to length.

Over the years, many proposals have been put forward for tools which simultaneously cut and bevel the pipe ends and examples are disclosed in (i) AU-2003231625 A1 (AMEC SERVICES PTY LTD); JP-606307, (iii) U.S. Pat. No. 4,180,358 (URIBE); (iv) U.S. Pat. No. 4,625,464 (KUBO); (v) U.S. Pat. No. 4,689,883 (DENT); (vi) U.S. Pat. No. 6,129,488 (FAHR); (vii) US 20050022353 (VIOLA et al); (viii) International Publication WO 98/16342 (CHINN et al).

All of these machines have features which limit their application. For example, U.S. Pat. No. 4,689,883 (DENT) requires the provision of a guide around the pipe to be cut and a cutting head which only has a single point of contact with the external wall of the pipe and so cannot ensure an accurate line of cut, or bevel, around the pipe.

U.S. Pat. No. 6,129,488 (FAHR) requires the use of an extremely complex cutting head to enable the pipes to be cut to length and bevelled.

### SUMMARY OF THE INVENTION

It is an object of the present invention to provide a pipe cutting and bevelling tool which can be used with pipes having a range of external diameters.

It is a preferred object of the present invention to provide a tool which can cut a range of bevel depths for a given pipe diameter.

It is a further preferred object of the present invention to provide a tool which is easy and safe to use.

It is a still further preferred object of the present invention to provide a tool which can be self-contained, or which can be powered from a remote power source.

Other preferred objects will become apparent from the following description.

In one aspect, the present invention resides in a pipe cutting and bevelling tool including:

a first guide plate;

at least one cutting tool and at least one bevelling tool extending through the first guide plate;

drive means to drive the cutting tool(s) and bevelling tool(s); and

a second guide plate pivotally mounted relative to the first guide plate, so arranged that:

by a single adjustment of an angular relationship between the first and second guide plates, the tool can cut and bevel pipes of different diameters, or can bevel ends of pipes of a single diameter to different bevel depths.

Preferably, the tool has a main frame, to which the first guide plate is mounted, and the cutting tool(s) and bevelling tool(s) are detachably mounted on a drive shaft journalled (in bushes or bearings) on the main frame.

Preferably, a cutting tool comprising a single saw blade or abrasive disc is interposed between a pair of bevelling tools, e.g., of the types known as dovetail or milling cutters or abrasive-coated drums, where the saw blade or abrasive disc extends through the first guide plate to a depth at least just greater than the wall thickness of the pipes to be cut and beveled.

Preferably, the bevelling cutters or abrasive-coated drums extend through the guide plate a reduced distance relative to the saw blade or abrasive disc, the reduced distance being preferably not less than the minimum thickness of landing faces at the ends of the pipes, after bevelling has been effected.

The drive means may include an internal combustion engine, an electric motor, a hydraulic motor, a pneumatic motor or other suitable power source, which may be self-contained, or connected to a remote power source, e.g., a hydraulic pump; and the engine or motor may be operably connected directly, or via a transmission, to the drive shaft.

Preferably, the second guide plate extends through a transverse slot or recess in the first guide plate and is pivotally mounted on the main frame or first guide plate.

Preferably, a screw-type adjuster interconnects the second guide plate to the main frame to enable the angular adjustment of the second guide plate to the first guide plate.

In a second aspect, the present invention resides in pipes cut and bevelled by the tool of the first aspect.

### BRIEF DESCRIPTION OF THE DRAWINGS

To enable the invention to be fully understood, preferred embodiments will now be described with reference to the accompanying drawings, in which:

FIG. 1 is an isometric view of one side of a first embodiment of the tool;

FIG. 2 is a similar view from the opposite side;

FIG. 3 is a similar view of the underside of the tool;

FIG. 4 is a bottom plan view thereof;

FIG. 5 is a side elevational view of the tool, with parts omitted for clarity;

FIG. 6 is a similar view, showing the tool in use with pipes of different diameters;

FIG. 7 is a similar view, showing the tool cutting bevels of different sizes for a single pipe diameter;

FIGS. 8 and 9 show the alternative bevels cut by the tool in FIG. 7;

FIG. 10 is a schematic side elevational view of a second embodiment of the tool; and

FIGS. 11 and 12 are respective schematic side and end elevational views of cutting and bevelling tools for metal pipes.

### DETAILED DESCRIPTION OF THE PREFERRED EMBODIMENTS

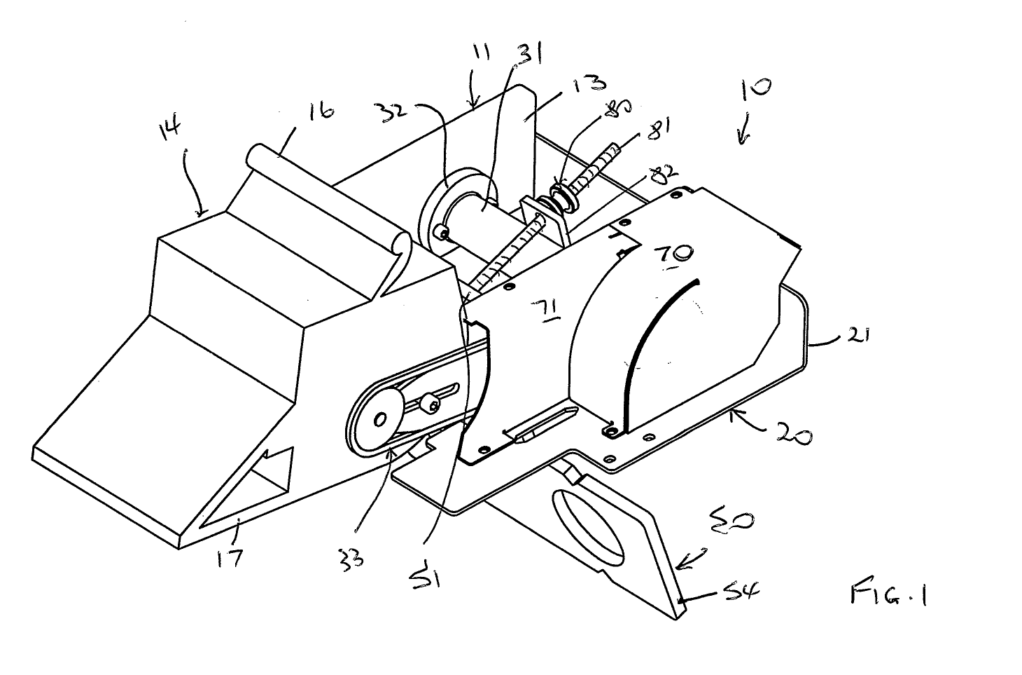

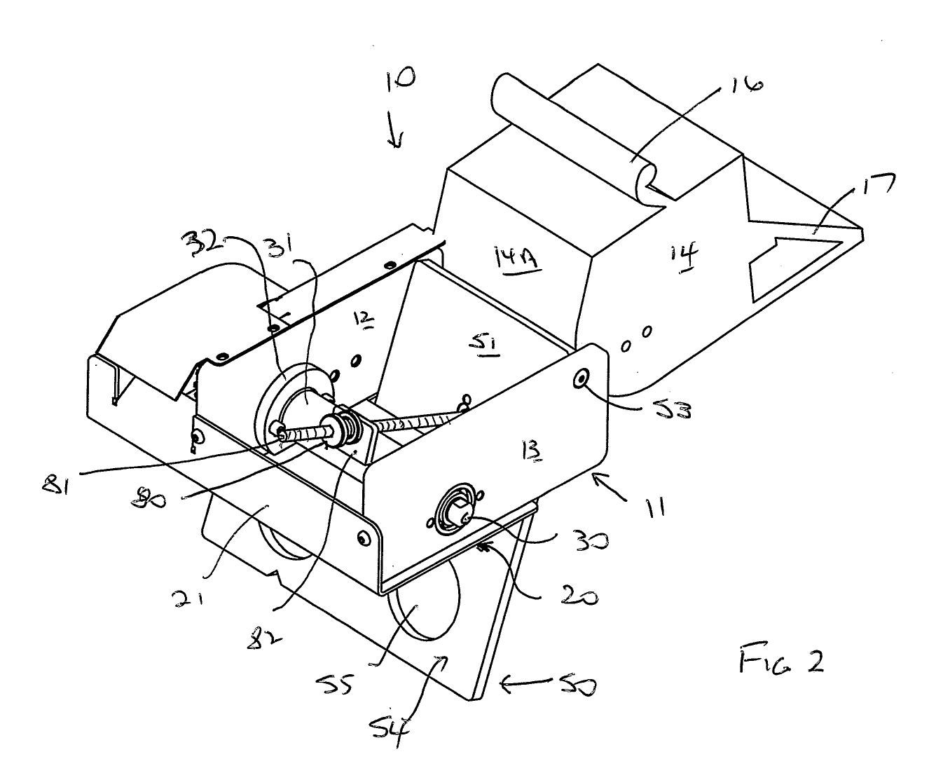

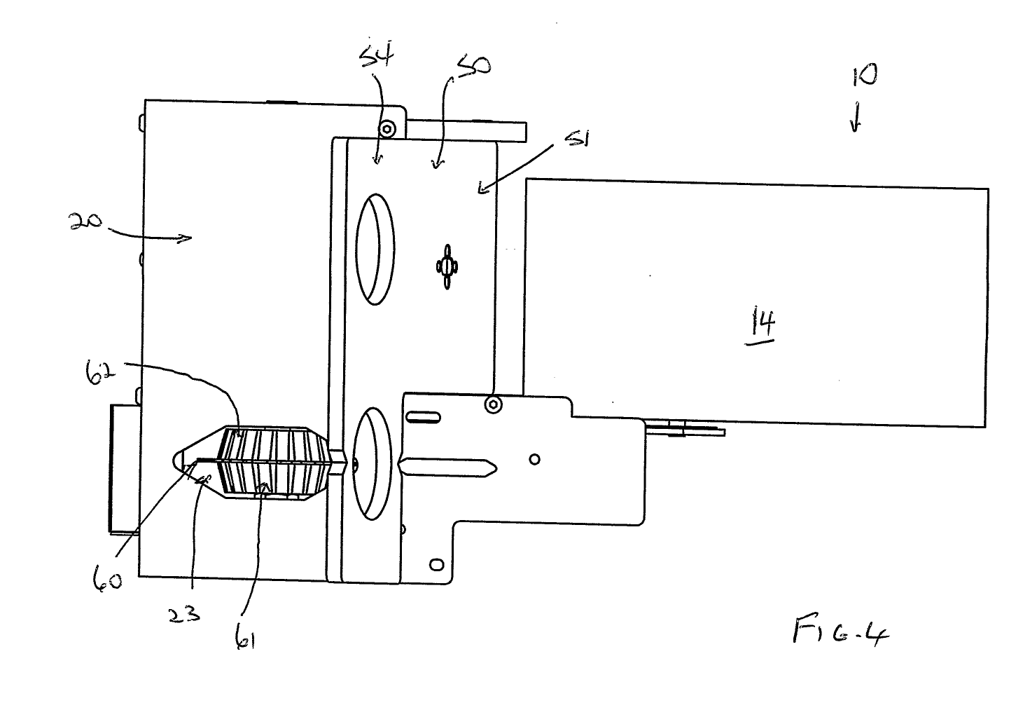

Referring to FIGS. 1 to 9, the pipe bevelling and cutting tool 10 of the first embodiment has a main frame 11 with a pair of spaced, parallel, side plates 12 and 13, to which is adjustably mounted a housing 14 for a small internal combustion engine 15.

The housing 14 is provided with respective handles or grips 16, 17.

A first guide plate 20 with an upturned front portion 21, is fixed to the side plates 12, 13 of the main frame 11 by suitable fasteners 22.

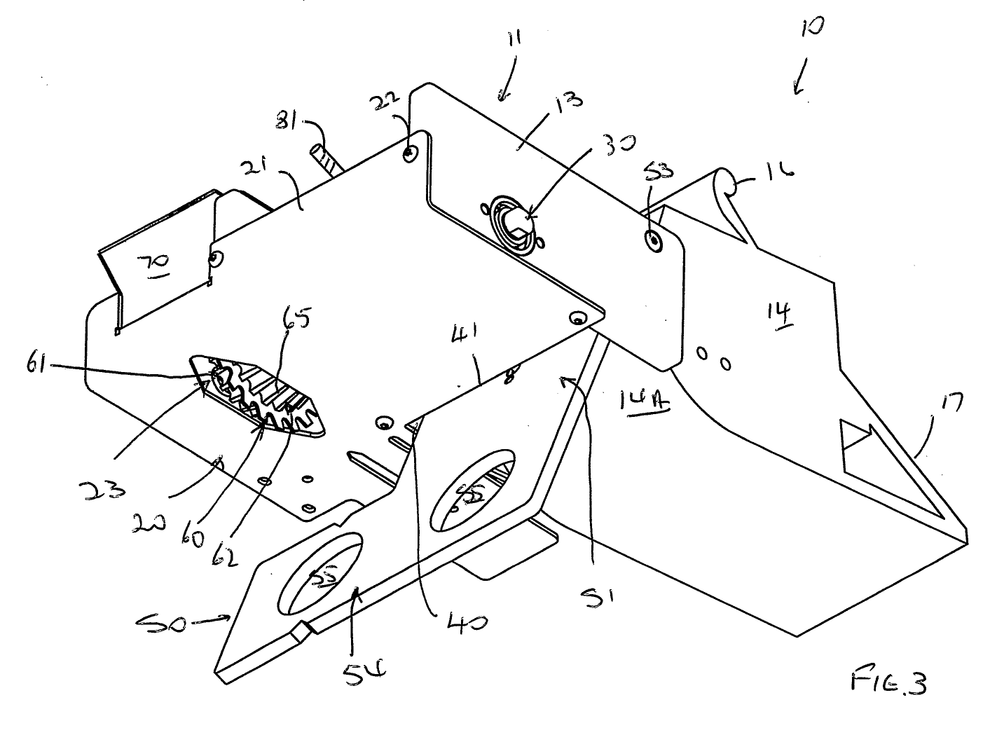

A hexagonally shaped slot 23, as shown in more detail in FIG. 3, is provided in the first guide plate 20 to allow the saw blade and bevelling cutters (to be hereinafter described in more detail) to extend therethrough.

A drive shaft 30 received within a tubular housing 31 is rotatably journalled in suitable bearings or bushes 32 mounted on the side plates 12, 13.

A drive chain or belt 33 is driven by a driving sprocket or pulley 34 fixed to the output shaft 18 of the engine 15.

While the drive chain or belt 33 passes around a guide plate 35 and drives a driven sprocket or pulley (not shown) on the drive shaft 30 (adjacent the side plate 12).

While the drive chain or belt 33 may be tensioned by a tensioning roller rotatably journalled on the side plate 12, in this embodiment, the guiding plate 35 has an elongate slot 37, engageable by a bolt or stud 19 in the housing 14, to allow the guiding plate 35 to be moved relative to the housing 14 so that the distance between the shafts 18, 30 to be selectively adjusted to maintain the correct tension in the drive chain or belt 33.

A second guide plate 50, of substantially L-shape in front view, has a top portion 51 extending through a slot 40 defined between a rear end wall 41 of the first guide plate 30 and the front wall 14A of the housing 14. The top portion 51 is pivotally connected to the side walls 12, 13, adjacent their upwardly rearward corners, by suitable pivot studs 52, 53.

The second guide plate 50 has a lower portion 54, with a pair of holes 55 therethrough, the lower portion 54 extending laterally relative to the upper portion 51 to extend across the full width of the first guide plate 20.

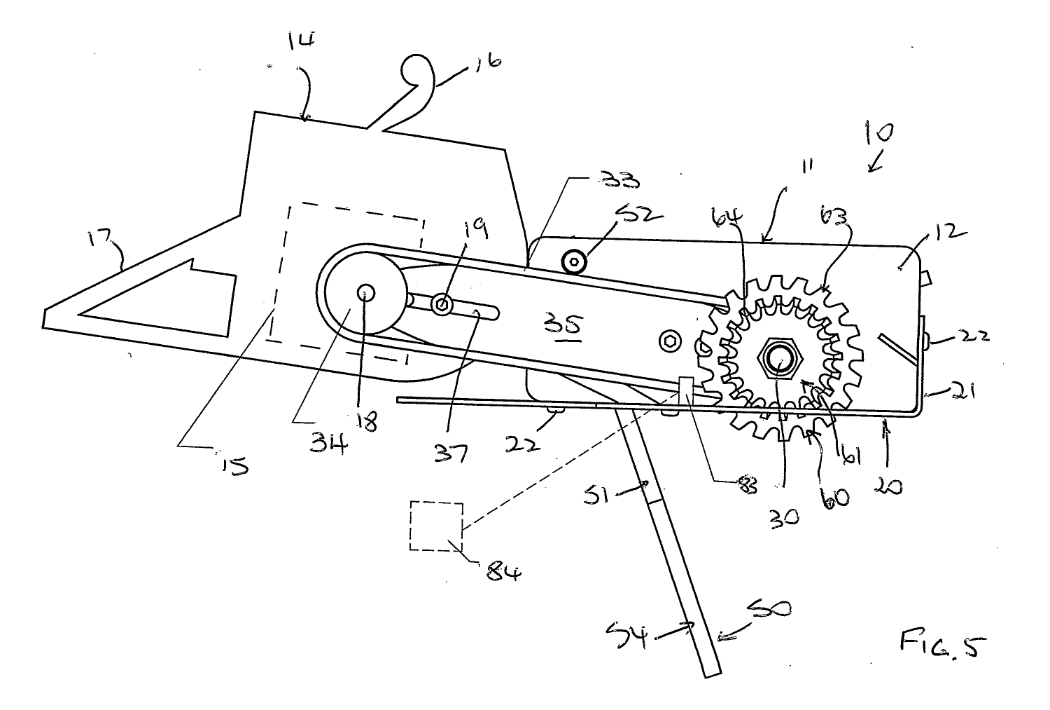

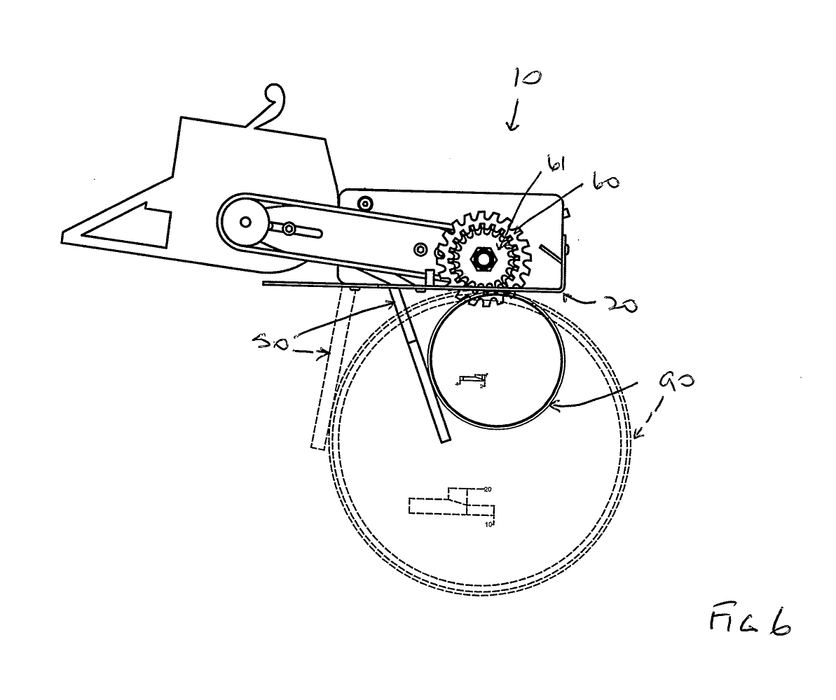

It will be noted that the pivotal axis of the second guide plate 50, defined by the pivot studs 52, 53, is perpendicular other cutting direction of the tool 10 as shown in FIGS. 6 and 7. The first and second guide plates 20, 50 co-operate to engage respective portions of the pipes to be cut to maintain the longitudinal axis of the pipes parallel to the drive shaft 30 and thereby perpendicular to the axes of the saw-blade and bevelling cutters to be hereinafter described.

A saw blade 60 is interposed between a pair of bevelling cutters 61, 62, which are provided on the drive shaft 30 and extend through the slot 23 in the first guide plate 20.

The saw blade 60 has teeth 63 appropriate to the cutting of the material, e.g., plastics or metal, of the pipes to be cut. Similarly, the bevelling cutters 61, 62, e.g., of the dovetail or milling cutter types, have respective cutting teeth 64, 65 profiled to cut the desired profile on the ends of the pipes. It will be noted that the cutting teeth 63 of the saw blade 60 extend further through the slot 23 than the teeth 64, 65 of the bevelling cutters 61, 62, preferably to a depth substantially equal to, or greater than, the thickness of the landing faces to remain on the pipes after the ends of the pipes have been cut and bevelled.

Removable covers 70, 71 are provided over the saw blade 60, bevelling cutters 61 and 62 and the driving chain or belt 33 to protect the operator of the tool 10.

Pivotal adjustment of the second guide plate 50 relative to the first guide plate 20 is effected by an adjustment nut 80 on a screw threaded rod 81 connected to the upper portion 51 of the second guide plate 50, the adjustment nut 80 bearing against a flange 82 on the tubular housing 31 for the drive shaft 30.

A water nozzle 83 is provided adjacent the saw blade 60 and bevelling cutters 61 and 62, to direct water or other liquid coolant from a coolant source 84 onto the saw blade 60 and the bevelling cutters 61, 62 when the pipes are being cut. Coolant is usually only required when cutting/bevelling metal pipes.

As shown in FIG. 6, by adjusting the angular relationship of the second guide plate 50 to the first guide plate 20, via adjustment nut 80, the tool 10 can cut and bevel pipes 90 with a wide range of diameters, e.g., 50 mm to 500 mm.

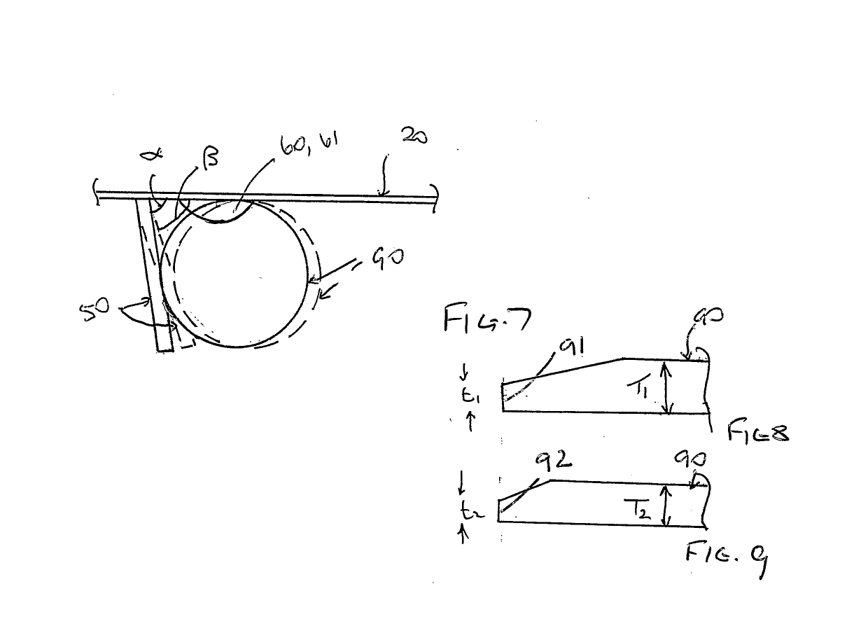

As shown schematically in FIG. 7, for pipes 90 of a given diameter, adjustment of the angular relationship, e.g., from the angle α (where the second guide plate 50 is shown in solid lines) to the angle β (where the second guide plate 50 is shown in dashed lines), different bevel profiles can be applied to the pipes 90 as shown in FIGS. 8 and 9.

In addition, for a given pipe diameter, but different pipe wall thicknesses T1, T2, the thickness t1, t2 of the land faces 91, 92 can be varied by selected angular adjustment of the second guide plate 50 relative to the first guide plate 20.

As the guide plates 20, 50 provide two, spaced, lines of contact with the walls of the pipes 90, the saw blade 60 will always cut the ends of the adjacent sections of the pipes 90 square to the longitudinal axis of the pipes 90 and the respective adjacent ends of the pipes 90 will be evenly bevelled by the respective bevelling cutters 61, 62.

The homing ability of the tool 10 to end the cuts of the pipes 90 where the cuts start, which results in the high quality of the cuts/bevels produced, is due to the feature that the guide plates 20, 50 provide parallel lines of contact with the pipes 90. The second guide plate 50 is already parallel to the drive shaft 30, and the drive shaft 30 and first guide plate are also always parallel. By maintaining the guide plates 20, 50 in contact with the pipes 90 as the cuts/bevels are formed, accuracy is ensured.

Where the pipes 90 are subject to variations in wall thicknesses due to manufacturing tolerances, the bevel depths cut will remain constant, as these start from the outer faces of the pipes 90 in contact with the guide plates 20, 50. (Any variation will be in the thickness of the land faces 91, 92.)

The pipes 90 may also be out-of-round, again due to manufacturing tolerances or localised damage during handling.

By having the line of contact between the pipes 90 and the first guide plate 20 aligned as close as possible to the axis of the drive shaft 30, any effects of the out-of-roundness of the pipes 90 is minimised, especially if the line of contact is directly under the output shaft 30.

Greater accuracy in the cutting/bevelling of the pipes 90 is possible with the present tool, than with previous machines where the pipes are cut at 360°, e.g., supported by rollers/wheels at 60° and 300°.

In addition, the lines of contact between the pipes 90 and the guide plates 20, 50, minimise the adverse effects of any localised deformations or variations in the outer faces of the pipes, where the rollers/wheels of the previous machines which may run into, e.g., recesses in the outer faces.

It will be readily apparent to the skilled addressee that the present invention provides simple, efficient, safe cutting and bevelling of the ends of the pipes using the tool 10 of the present invention.

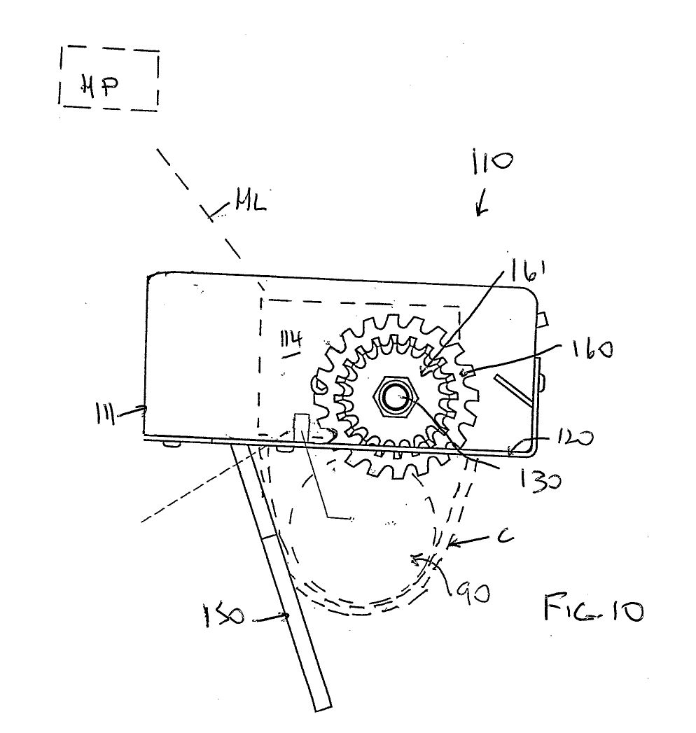

In a second embodiment illustrated in FIG. 10, the tool 110 may be used to cut pipes 90 in situ in trenches or other locations where limited access is available. In this embodiment, the internal combustion engine 14 is replaced by a hydraulic motor 114 connected to a remote hydraulic pump HP by suitable hydraulic lines HL. The hydraulic motor 114 can be directly connected to, or provide, the drive shaft 130, for the saw blades 160 and bevelling cutters 161.

It will be readily apparent to the skilled addressee that the hydraulic motor 114 can be replaced by a pneumatic motor or electric motor, each connected to a respective remote power source.

To assist in maintaining the pipes 90 in contact with the first and second guide plates 120, 150 of the tool 110, a flexible restraint or clamp C may be mounted on, or connected to, the main frame 111 of the tool 110.

The relatively compact nature of the tool 110 enables it to be used on pipes 90 in situ, where the tool 110 is moved around the pipes 90 to accurately cut and bevel the pipe ends.

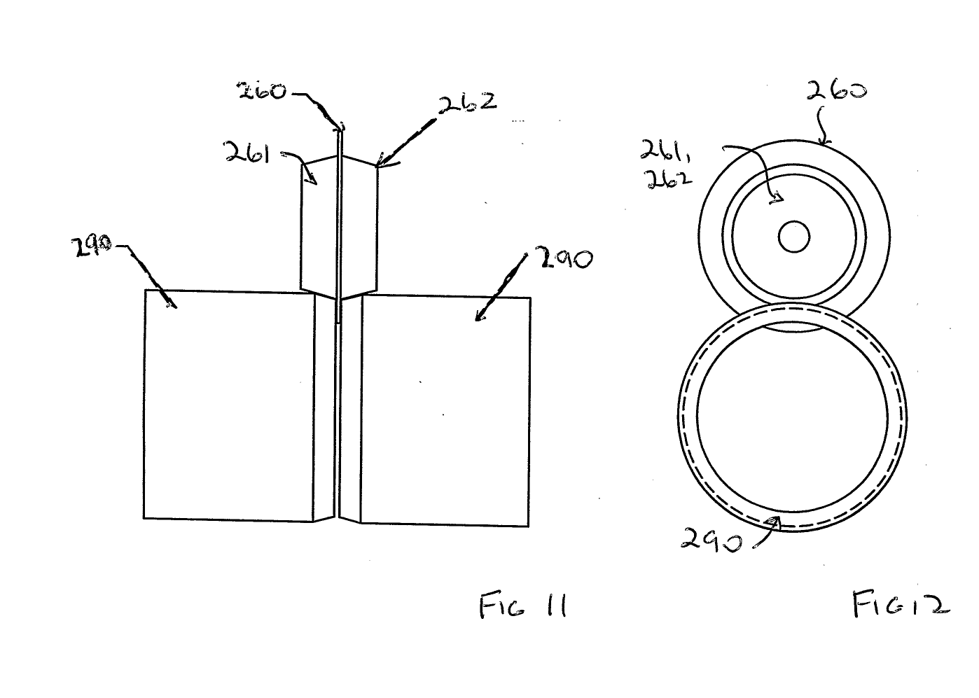

As illustrated in FIGS. 11 and 12, the saw blades 60, 160 and bevelling cutters 61, 62, 161 may be replaced with abrasive discs 260 and drums 261, 262, with appropriate abrasive coatings, to cut and bevel metal pipes 290. The abrasive coatings for iron pipes are preferably diamonds; while the preferred abrasive coatings for steel pipes are CBN or Ambercite. Other suitable abrasive coatings, e.g., tungsten carbide, may be used.

The present invention provides a simple, efficient tool for cutting and bevelling the ends of pipes; where accuracy is ensured; and safety of the operators is important.

Unlike prior tools, a single adjustment of the second guide plate 50, 150 relative to the first guide plate 20, 120, enables pipes 90 of a wide range of diameters to be cut and bevelled, or different bevelled profiles be applied to pipes 90 of a single diameter.

Various changes and modifications may be made to the embodiments described and illustrated without departing from the present invention.

1. A pipe cutting and bevelling tool including:
a first guide plate;
at least one cutting tool and at least one bevelling tool extending through the first guide plate;
drive means to drive the cutting tool(s) and bevelling tool(s); and
a second guide plate pivotally mounted relative to the first guide plate, so arranged that:
by a single adjustment of an angular relationship between the first and second guide plates, the tool can cut and bevel pipes of different diameters, or can bevel ends of pipes of a single diameter to different bevel depths.

2. The tool as claimed in claim 1, wherein:
the tool has a main frame, to which the first guide plate is mounted, and the cutting tool(s) and bevelling tool(s) are detachably mounted on a drive shaft journalled on the main frame.

3. The tool as claimed in claim 1, wherein:
a cutting tool comprising a single saw blade or abrasive disc is interposed between a pair of bevelling tools of the types known as dovetail or milling cutters or abrasive-coated drums or abrasive discs, where the saw blade extends through the first guide plate to a depth at least just greater than the wall thickness of the pipes to be cut and beveled.

4. The tool as claimed in claim 3, wherein:
the bevelling cutters or abrasive-coated drums extend through the guide plate a reduced distance relative to the saw blade or abrasive disc, the reduced distance being not less than the minimum thickness of landing faces at the ends of the pipes, after bevelling has been effected.

5. The tool as claimed in claim 1, wherein:
the drive means includes an internal combustion engine, an electric motor, a hydraulic motor, a pneumatic motor or other suitable power source, self-contained or connected to a remote power source; e.g., and the engine or motor is operably connected directly, or via a transmission, to the drive shaft.

6. The tool as claimed in claim 1, wherein:
the second guide plate extends through a transverse slot or recess in the first guide plate and is pivotally mounted on the main frame or first guide plate.

7. The tool as claimed in claim 6, wherein:
a screw-type adjuster interconnects the second guide plate to the main frame to enable the angular adjustment of the second guide plate to the first guide plate.

8. A pipe cut and bevelled by the tool of claim 1.

9. The tool as claimed in claim 2, wherein:
a cutting tool comprising a single saw blade or abrasive disc is interposed between a pair of bevelling tools of the types known as dovetail or milling cutters or abrasive-coated drums or abrasive discs, where the saw blade extends through the first guide plate to a depth at least just greater than the wall thickness of the pipes to be cut and beveled.

10. The tool as claimed in claim 9, wherein:
the bevelling cutters or abrasive-coated drums extend through the guide plate a reduced distance relative to the saw blade or abrasive disc, the reduced distance being not less than the minimum thickness of landing faces at the ends of the pipes, after bevelling has been effected.

11. The tool as claimed in claim 10, wherein:
the drive means includes an internal combustion engine, an electric motor, a hydraulic motor, a pneumatic motor or other suitable power source, self-contained or connected to a remote power source; e.g., and the engine or motor is operably connected directly, or via a transmission, to the drive shaft.

12. The tool as claimed in claim 11, wherein:
the second guide plate extends through a transverse slot or recess in the first guide plate and is pivotally mounted on the main frame or first guide plate.

13. The tool as claimed in claim 12, wherein:
a screw-type adjuster interconnects the second guide plate to the main frame to enable the angular adjustment of the second guide plate to the first guide plate.
